(19) United States
(12) Patent Application Publication
(10) Pub. No.: US 2007/0092633 A1
(43) Pub. Date: Apr. 26, 2007

(54) Soy protein product with a high sterol and tocopherol content and process for its manufacture

(76) Inventor: Navpreet Singh, St. Louis, MO (US)

Correspondence Address: SOLAE, LLC, PO BOX 88940, ST LOUIS, MO, 63188, US

(21) Appl. No.: 11/257,634

(22) Filed: Oct. 25, 2005

(51) Int. Cl. A23J 1/00

(52) U.S. Cl. 426/656

(57) ABSTRACT

Soy protein products, such as soy protein isolates and soy protein concentrates, and processes for producing the same are disclosed. The soy protein products are produced from a partially defatted soybean starting material without the use of hexane or other organic solvents. The soy protein products have a high sterol and/or tocopherol content, and may be used in a variety of food products.

### FIELD OF THE DISCLOSURE

The present disclosure generally relates to soy protein products, such as soy protein isolates and soy protein concentrates, and processes for producing the same. The soy protein products are produced using a partially defatted soybean starting material. Advantageously, the soy protein products have a high sterol and/or tocopherol content, and are produced without the use of hexane or other organic solvents.

### BACKGROUND OF THE DISCLOSURE

Proteins derived from soybeans have been utilized as an edible source of proteins for some time, and are commonly included in a number of consumer food items, including meat products, fishery paste products, side dishes, bread, confectionery products, and acidic beverages. The added protein provides an additional source of nutrition in the food or beverage products. Recently, it has been discovered that soy proteins provide additional health benefits, such as reducing blood cholesterol levels, as well as providing excellent nutritional benefits. As a result, there has been growing consumer demand for food items containing these proteins.

Suitable soy protein materials for use in food products include soy flakes, soy flour, soy grits, soy meal, soy protein concentrates, soy protein isolates, and mixtures thereof. The primary difference between these soy protein materials is the degree of refinement relative to whole soybeans.

Soy flakes are generally produced by dehulling, defatting, and flaking the soybean and typically contain less than about 65% (by weight) soy protein on a moisture-free basis. Soy flakes also contain soluble carbohydrates and insoluble carbohydrates such as soy fiber. Soy flakes may be defatted, for example, by extraction with hexane. The defatted materials are typically heat treated with dry heat or steamed with moist heat to “toast” the ground flakes and inactivate anti-nutritional elements present in soy such as Bowman-Birk and Kunitz trypsin inhibitors. Heat treating the ground flakes in the presence of significant amounts of water is avoided to prevent denaturation of the soy protein in the material and to avoid costs involved in the addition and removal of water from the soy material. Soy flours, soy grits, and soy meals are typically produced from defatted soy flakes by comminuting the flakes in grinding and milling equipment such as a hammer mill or an air jet mill to a desired particle size. The resulting ground, heat treated material is a soy flour, soy grit, or a soy meal, depending on the average particle size of the material. Soy flour generally has a particle size of less than about 150 μm. Soy grits generally have a particle size of about 150 to about 1000 μm. Soy meal generally has a particle size of greater than about 1000 μm.

Soy protein concentrates typically contain from about 65% (by weight) to less than 90% (by weight) soy protein on a moisture free basis, with the major non-protein component being fiber. Soy protein concentrates are typically formed from defatted soy flakes by washing the flakes with either an aqueous alcohol solution or an acidic aqueous solution to remove the soluble carbohydrates from the protein and fiber.

Soy protein isolates, which are more highly refined soy protein materials, are processed to contain at least 90% (by weight) soy protein on a moisture free basis and little or no soluble carbohydrates or fiber. Soy protein isolates are typically formed by extracting soy protein and water soluble carbohydrates from defatted soy flakes or soy flour with an aqueous extractant. The aqueous extract, along with the soluble protein and soluble carbohydrates, is separated from materials that are insoluble in the extract, mainly fiber. The extract is typically then treated with an acid to adjust the pH of the extract to the isoelectric point of the protein to precipitate the protein from the extract. The precipitated protein is separated from the extract, which retains the soluble carbohydrates, and is dried after an optional pH adjustment step.

In addition to the health benefits provided from ingesting soy proteins, soybeans and products derived therefrom may be a source of sterol and tocopherol compounds. Sterols compounds may help reduce total and LDL cholesterol levels in the blood. Phytosterols are sterol compounds produced by plants, and include β-sitosterol, campesterol, and stigmasterol, among others. Tocopherols (e.g., vitamin E) are fat soluble vitamins that are well known for their antioxidant properties. Tocopherols may also help prevent or delay the development of certain diseases such as cardiovascular disease and cancer. A variety of tocopherols may be found in soybeans, including δ-tocopherol, α-tocopherol, and γ-tocopherol, among others.

Sterols and tocopherols are typically associated with the fat or oil portion of a soybean. Typically, however, soy protein products are produced from substantially defatted soybean flakes or flour. Since much of the oil is removed from the soybean during the defatting process, many of the beneficial sterols and tocopherols may subsequently be lost during the defatting process, resulting in a soy protein isolate or concentrate that has little or no sterol or tocopherol content. As such, a need exists in the industry for soy protein products that have a high content of sterols and/or tocopherols, and a method for producing such products.

### SUMMARY OF THE DISCLOSURE

The present disclosure is generally directed to soy protein products, such as soy protein concentrates and soy protein isolates, which comprise a high sterol and/or tocopherol content, and methods of producing the same. More specifically, the soy protein products are produced from a partially defatted soybean starting material, such as partially defatted soy flour or soy flakes, and have a high sterol and/or tocopherol content. Advantageously, the soy protein products are produced without the use of an organic solvent, such as hexane, which is conventionally used during the defatting process.

Thus, in one embodiment, the present disclosure is directed to a process for producing a soy protein product. The process comprises: (a) contacting a partially defatted soybean starting material having a fat content by acid hydrolysis of from about 6 wt. % (dry weight basis) to about 20 wt % (dry weight basis) with a hydrating solution to form a slurry; (b) removing fiber from the slurry to produce a suspension; and (c) ultrafiltering the suspension using a membrane having a molecular weight cutoff (MWCO) of between about 1,000 and about 30,000 Daltons to form the soy protein product. The soy protein product has a protein content of at least about 65 wt. % (total dry matter) and a total sterol content of at least about 200 ppm (total dry matter).

In another embodiment, the present disclosure provides a soy protein product comprising a protein content of at least about 65 wt. % (total dry matter); a fat content by acid hydrolysis of at least about 6 wt. % (dry weight basis); and a total sterol content of at least about 200 ppm (total dry matter).

In still another embodiment, the present disclosure provides a soy protein product comprising a protein content of at least about 65 wt. % (total dry matter); a fat content by acid hydrolysis of at least about 6 wt. % (dry weight basis); and a total mn content of at least about 5 ppm (total dry matter).

### DETAILED DESCRIPTION OF THE INVENTION

The present disclosure is generally directed to soy protein products, such as soy protein concentrates and soy protein isolates, that have a high sterol and/or tocopherol content, and a process for producing the soy protein products. The soy protein products advantageously are produced from a partially defatted soybean starting material, and without the use of organic solvents, such as hexane, and, as such, can be utilized as a starting material in organic certified product lines.

Soy protein products are typically produced using substantially fully defatted soy protein material. In order to produce defatted soy protein material, extraction procedures typically remove soybean oil from soy flakes by using solvents, such as hexane or heptane. One disadvantage with this procedure is that the resulting defatted soybean material may contain residual traces of the organic solvent. Additionally, as discussed above, by producing a soy protein product using a defatted soy protein starting material, beneficial sterols and tocopherols may be lost during the defatting process. For example, a soy protein product produced using a defatted soy protein starting material typically comprises less than 150 ppm sterols, and less than 5 ppm tocopherols.

Thus, the present disclosure provides a method of producing soy protein products using a partially defatted soy starting material prepared without the use of organic solvents, such as hexane or heptane. The present method generally encompasses: 1) providing a partially defatted soybean starting material; 2) contacting the partially defatted soybean starting material with a hydrating solution to form a slurry; 3) removing fiber from the slurry, while retaining proteins; and 4) ultrafiltering to remove carbohydrates and minerals. This process advantageously results in a soy protein product with a high content of sterols and tocopherols.

The partially defatted soy protein starting material is generally prepared by: 1) detrashing whole soybeans; 2) cracking the detrashed soybeans; 3) optionally dehulling the cracked soybeans; 4) optionally flaking the dehulled soybeans; and 5) partially defatting the cracked or dehulled soybeans or flakes without the use of an organic solvent, such as hexane or heptane. Typically, the soybeans are partially defatted using mechanical means, instead of solvents, as described below.

The partially defatted soybean starting material may be produced from commodity or non-commodity soybeans. Additionally, the partially defatted soybean starting material may be produced from genetically modified soybeans. Initially, the soybeans are detrashed by passing the soybeans through a magnetic separator to remove iron, steel, and other magnetically susceptible objects, followed by shaking the soybeans on progressively smaller meshed screens to remove soil residues, pods, stems, weed seeds, undersized beans, and other trash. The detrashed soybeans are then cracked by passing the soybeans through cracking rolls. Cracking rolls are spiral-cut corrugated cylinders which loosen the hull as the soybeans pass through the rolls and crack the soybean material into several pieces. Optionally and preferably the cracked soybeans are conditioned to 10% to 11% moisture at 63 to 74° C. Optionally, the cracked soybeans are then dehulled, preferably by aspiration. Soy hypocotyls, which are much smaller than the cotyledons of the soybeans, may be removed by shaking the dehulled soybeans on a screen of sufficiently small mesh size to remove the hypocotyls and retain the cotyledons of the beans. The hypocotyls need not be removed since they comprise only about 2%, by weight, of the soybeans while the cotyledons comprise about 90% of the soybeans by weight. However, it is generally preferred to remove the hypocotyls since they are often associated with the beany taste of soybeans. Optionally, the dehulled soybeans, with or without hypocotyls, may be flaked by passing the soybeans through flaking rolls. The flaking rolls are smooth cylindrical rolls positioned to form flakes of the soybeans as they pass through the rolls having a thickness of from about 0.01 inch (0.03 cm) to about 0.015 inch (0.04 cm).

The cracked soybeans or dehulled soybeans or flakes may then be partially defatted. The cracked soybeans or dehulled soybeans or flakes may be processed through an extruder, preferably a single screw extruder. Dry extrusion is used as a shearing and heating pretreatment to disrupt the cellular organization of the seed and free the oil in cracked soybeans or dehulled soybeans or flakes. The extruder consists of a flighted screw that rotates in a tight-fitting barrel to convey and compress the feed material, which is pressed into a dough-like material. As the material progresses toward the die of the extruder, both temperature and pressure increase as a result of the relatively shallow screw flights and increased restriction. The sudden pressure drop as the feed material is forced through the die causes expansion of the extrudate. Entrapped water vaporizes or flashes off due to the high internal temperature. All of these events cause disruption of cell walls and subcellular organizations and free the oil held in spherosomes. The temperature during extrusion is monitored and preferably maintained at or less than 275° F., preferably at or less than 230° F. The cracked soybeans or dehulled soybeans or flakes conditioned by the extruder are partially defatted using a mechanical expeller, also referred to as continuous screw press. The expeller or screw press removes the oil by pressing it out. Extruding prior to expelling greatly increases the throughput of the expeller. However, the pretreatment by extruder is optional and the cracked soybeans or dehulled soybeans or flakes could be fed directly to an expeller or screw press. The temperature during the mechanical expression of oil in an expeller or screw press is monitored and maintained at or less than 130° F. Preferably, the partially defatted cake exiting the expeller or screw press is ground using a pin mill while monitoring temperature and maintaining temperature at or less than 140° F. The pin mill is preferably jacketed and more preferably cooled during grinding. The material may then be ground to produce a partially defatted soy flour such that partially defatted soy flour has a particle size wherein at least 97%, by weight, of the flour has a particle size of 150 microns or less (is capable of passing through a No. 100 mesh U.S. Standard Screen).

Thus, in one embodiment, the starting material, which can be partially defatted soy flour or soy flakes, is produced according to the process described above. Advantageously, the partially defatted soy flour or soy flakes produced by this process is produced without the use of an organic solvent, such as hexane or heptane, and is therefore free of any organic solvent residue.

The fat content of the partially defatted soybean starting material may be measured by acid hydrolysis, which measures all of the fat content of the soy material. The total amount of fat in the partially defatted starting material (weight percent) can be measured using fat hydrolysis according to the Official Methods of Analysis of the AOAC International, 16th Edition, Method 922.06, Locator 32.1.13 (Modified). This method includes taking a 1.0-2.0-gram sample of the partially defatted starting material and hydrolyzing the sample with dilute acidic alcohol to free heat-bound fats and oils contained in the sample. The fat is then extracted with a mixture of ethyl ether and petroleum ether, which is subsequently volatilized leaving the fat. The fat is dried, weighed, and quantitated as percent fat. A control sample is analyzed with each set of partially defatted starting material samples. Specifically, the following procedure may be used.

Step 1

A 1.0-gram sample of the partially defatted starting material is placed in a Mojonnier fat extraction flask (Type G-3, Mayer Co., Charleston, S.C.); 2.0 milliliters SDA (Specially Denatured Alcohol) and 10 milliliters dilute HCl (440 milliliters deionized water mixed with 1 L 12 N HCl) are added to the partially defatted starting material sample in the Mojonnier fat extraction flask.

Step 2

The sample is agitated in a water bath at 70-80° C. for a total of 45 minutes or until hydrolysis is complete. Hydrolysis is deemed complete when the sample slurry is gray to black in color and no large chunks remain.

Step 3

The hydrolyzed sample is removed from the water bath, and 5 milliliters of SDA are added to the hydrolyzed sample in the Mojonnier fat extraction flask. The hydrolyzed sample is swirled gently by hand and then allowed to cool to room temperature.

Step 4

The fat is then extracted from the hydrolyzed sample by a mixture of ethyl ether and petroleum ether by the following process:
a. Add 25 milliliters ethyl ether to the Mojonnier fat extraction flask, tighten the stopper, shake vigorously by hand for I minute and remove the stopper.
b. Add 25 milliliters petroleum ether to the Mojonnier fat extraction flask, tighten the stopper, shake vigorously by hand for I minute and remove stopper to release pressure.
c. Centrifuge flask for 2 minutes at a speed sufficient to separate the solution into two distinct layers.
d. Prepare a stemless filter funnel with a cotton plug packed just firmly enough into the small funnel opening to allow ether to pass through freely and place the funnel on top of a tared 250-milliliter Griffin beaker.
e. Decant as much as possible of the sample's ether-fat solution (top layer in the Mojonnier fat extraction flask) through the prepared filter funnels.
f. Re-extract the hydrolyzed sample with 15 milliliter portions of ethyl ether and 15 milliliter portions of petroleum ether at least two more times repeating steps a-e, or until extracts are colorless.
g. Filter the top layer through the filter into the Griffin beaker that contains the original extract.
h. After the final extraction and filtration, rinse the funnel and cotton plug with three separate ethyl ether washes of about 10 milliliters each, collecting the rinses in the Griffin beaker containing the extracts.
   Step 5

The Griffin beaker containing the fat extracts is then placed on a steam bath at low setting under a hood to evaporate the ether; when all solvent has evaporated from the Griffin beaker, it is removed from the steam bath and the outside of the Griffin beaker is dried; the Griffin beaker is then placed in a forced-draft oven at 101° C. for 30-35 minutes; the Griffin beaker is then removed from the oven, placed in a dessicator to allow to cool about 30 minutes; the Griffin beaker is then removed from the dessicator and allowed to come to room temperature.

Step 6

The Griffin beaker is then weighed and the gross weight recorded.

Step 7

The % Fat is calculated using the following formula:
% Fat=(100)(G−T)/S

Where: G=Gross weight of Griffin beaker,
T=Tare weight of Griffin beaker,
100=Conversion factor to %
S=Sample weight

Using a 2-gram sample, the lowest confidence level of this method is 0.1% fat.

The partially defatted soybean starting material described herein for use in the processes of the present disclosure will typically have a total fat content (weight percent) as measured by acid hydrolysis of at least about 6 wt. % (dry weight basis). Preferably, the partially defatted soybean starting material will have a total fat content as measured by acid hydrolysis of from about 6 wt % (dry weight basis) to about 20 wt % (dry weight basis), more preferably from about 8 wt % (dry weight basis) to about 18 wt % (dry weight basis), and still more preferably from about 9 wt % (dry weight basis) to about 15 wt % (dry weight basis).

The partially defatted soybean starting material may also be characterized in termns of the Protein Dispersibility Index (PDI). As used herein, PDI is defined as:
PDI=(% water-dispersible protein in the protein containing sample/% total protein in the protein containing sample)×100

The PDI provides a measure of the percent dispersible protein in the sample. PDI is measured in accordance with standard analytical methods, specifically by American Oil Chemists' Society (AOCS) method Ba 10-65, incorporated herein by reference. According to method Ba 10-65, 20 grams of a soy material sample is added to 50 milliliters of distilled water at 25° C., and stirred (e.g., with a spatula) to form a paste. 250 milliliters of distilled water is 25° C. is added to the paste and the resulting sample is blended for 10 minutes at 8500 rpm to form a slurry. The slurry is allowed to separate, and a portion of the upper layer is subsequently decanted or pipetted off and centrifuged for 10 minutes at 2700 rpm. 15 milliliters of the supernatant is pipetted off and analyzed for Kjeldahl nitrogen to determine the percent of water-dispersible protein in the sample according to AOCS Official Methods Aa 5-91 or Ba 4d-90. A separate portion of the soy protein sample is analyzed for total protein. The protein content of each sample (P value) may be determined using a Kjeldahl or Kjel-Foss analysis. For example, the Nitrogen-Ammonia-Protein Modified Kjeldahl Method according to AOCS Methods Bc4-91 (1997), Aa 5-91 (1997), and Ba 4d (1997) may be used to determine the protein content of the soy protein sample. Specifically, the following procedure may be used.

Step 1

0.0250-1.750 grams of the soy sample are weighted into a standard Kjeldahl flask. A commercially available catalyst mixture of 16.7 grams potassium sulfate, 0.6 grams titanium dioxide, 0.01 grams of copper sulfate, and 0.3 grams of pumice is added to the flask, followed by 30 milliliters of concentrated sulfuric acid.

Step 2

Boiling stones are added to the mixture, and the sample is digested by heating the sample in a boiling water bath for approximately 45 minutes. The flask should be rotated at least 3 times during the digestion.

Step 3

300 milliliters of water is added to the sample, and the sample is cooled to room temperature.

Step 4

Standardized 0.5N hydrochloric acid and distilled water are added to a distillate receiving flask sufficient to cover the end of a distillation outlet tube at the bottom of the receiving flask.

Step 5

Sodium hydroxide solution is added to the digestion flask in an amount sufficient to make the digestion solution strongly alkaline.

Step 6

The digestion flask is then immediately connected to the distillation outlet tube, the contents of the digestion flask are thoroughly mixed by shaking, and heat is applied to the digestion flask at about a 7.5-min boil rate until at least 150 milliliters of distillate is collected.

Step 7

The contents of the receiving flask are then titrated with 0.25N sodium hydroxide solution using 3 or 4 drops of methyl red indicator solution—0.1% in ethyl alcohol.

Step 8

A blank determination of all the reagents is conducted simultaneously with the sample and similar in all respects, and correction is made for blank determined on the reagents.

Step 9

The nitrogen content of the sample is determined according to the formula:
Nitrogen (%)=1400.67×[[(Normality of standard acid)×(Volume of standard acid used for sample (ml))]
−[(Volume of standard base needed to titrate 1 ml of standard acid minus volume of standard base needed to titrate reagent blank carried through method and distilled into 1 ml standard acid (ml))×(Normality of standard base)]−[(Volume of standard base used for the sample (ml))×(Normality of standard base)]]/(Milligrams of sample).

The protein content is 6.25 times the nitrogen content of the sample.

The values of percent water-dispersible protein and percent total protein are utilized in the formula above to calculate the Protein Dispersibility Index.

Typically, when testing the partially defatted starting material, the partially defatted starting material may have a protein dispersibility index (PDI) of at least about 60%, preferably at least about 70%, and more preferably at least about 75%.

In other embodiments, the partially defatted starting material may be commercially obtained. For example, partially defatted soy flour that has fat content by acid hydrolysis of at least about 6 wt % dry weight basis but less than about 15 wt % dry weight basis and a protein dispersibility index of at least about 60%, is freely and conumercially available from several vendors including, for example, US Soy (Mattoon, Ill.).

Once the partially defatted starting material is produced or obtained, fiber may be removed from the starting material. In this step, the partially defatted starting material is typically contacted with a hydrating solution comprising water, for example, to form a slurry. As used herein, the term “hydrating” refers to a static or dynamic soaking of the partially defatted starting material to introduce water therein. Typically, the water is pre-heated to a temperature of about 25° C. to about 65° C. prior to contacting with the partially defatted starting material. Generally, a sufficient amount of water is used so that the slurry contains about 5-15 wt. % solids. It usually is necessary to provide some agitation or mixing to slurry the starting material. One means for performing the mixing is a propeller-type agitator. Typically, mixing may occur for about 5 to about 45 minutes. The pH of the slurry may be adjusted to from about 7.0 to about 11.0 using, for example, a sodium hydroxide solution, or any other suitable alkali. The pH may be adjusted when the partially defatted starting material is hydrated prior to mixing, or may be adjusted during mixing, preferably within the first five minutes of mixing.

The separation of fiber from the slurry can be performed by any one of a number of physical separation means, such as by centrifugation using a decanting centrifuge, for example. In one embodiment, co-current centrifugation is performed. In this embodiment, the slurry is subjected to centrifugation at from about 3000 to about 4000×g centrifugal force in a continuous process. The resulting centrifugation cake containing fiber is separated from the suspension, and the suspension is collected. The centrifugation may then optionally be repeated one or more times by re-slurrying the centrifugation cake, under the conditions described above, and centrifuging the resulting slurry. The suspensions collected from the centrifugation steps may then optionally be combined and further processed, as described below.

In another embodiment, countercurrent centrifugation may be performed. In this embodiment, the slurry is subjected to centrifugation at from about 3000 to about 4000×g centrifugal force in a continuous process. The resulting centrifugation cake containing fiber is separated from the suspension and the suspension from this first centrifugation is collected. The centrifugation cake may then be re-slurried, under the conditions described above, and the resulting slurry centrifuged. The suspension collected from this second centrifugation may then be used as a hydrating solution, and contacted with partially defatted soybean starting material to form a slurry. If needed, a sufficient amount of water may also be added to the slurry so that the slurry contains about 5-15 wt. % solids. The centrifugation steps may then optionally be repeated one or more times. The suspension collected from the first centrifugation step may be further processed, as described below.

Because the soy proteins present in the slurry are good emulsifiers, most of the fat present in the soy protein starting material forms an emulsion with the soy proteins during centrifugal separation. This is illustrated by the relatively low crude fat content in the final soy protein product, discussed below.

Optionally, the pH of the slurry or suspension may be adjusted to a more neutral pH. For example, if the pH of the slurry or suspension is above 7.5, it may be preferable to adjust the pH of the slurry or suspension to a pH of from about 7.0 to about 7.5, and more preferably to a pH of about 7.2. The pH may be adjusted by adding, for example, hydrochloric acid or any suitable acid to the slurry or suspension. In one embodiment, the pH of the suspension collected from the centrifugation steps may be adjusted prior to heat treatment, described below.

In one embodiment of this disclosure, the suspension may then be subjected to a heat treatment. The heat treatment acts to pasteurize or sterilize the suspension prior to ultrafiltration. In addition, heat treatment improves the nutritional value of the soy protein product by decreasing antinutritional factors, such as trypsin inhibitors, resulting in a soy protein product that has better digestibility. One means for heat treatment is jet cooking at a high temperature, for example, at a temperature of about 70° C. to about 170° C., preferably about 110° C. to 160° C. for from about 9 seconds to about 30 seconds, preferably for about 30 seconds. In yet another embodiment this disclosure, the suspension may be heat treated in a steam-jacketed kettle. Following heat treatment, the suspension may be cooled to a temperature of about 20° C. to about 50° C.

The slurry or suspension may then be subjected to an ultrafiltration process. Ultrafiltration removes carbohydrates and other low molecular weight compounds, such as minerals and small peptides, from the slurry or suspension, while retaining sterols and tocopherols in the retentate. As discussed above, sterols and tocopherols are fat soluble and associate with the fat present in the suspension or slurry. Without being bound to any particular theory, it is believed that the fat forms an emulsion with the proteins in the slurry or suspension, and this emulsion, including sterols and tocopherols, is retained by the ultrafiltration membranes in the retentate. Typically, about 70 wt. % to about 90 wt. % of the feed volume is removed as permeate during the ultrafiltration, resulting in a retentate having a protein content of at least about 65 wt. % of total dry matter. Preferably, the retenate contains protein at about 65 to about 75 wt. % of total dry matter.

Any membrane including spiral-wound membranes with a molecular weight cutoff(MWCO) of up to about 30,000 Daltons (Da) is suitable for the ultrafiltration step. Preferably, a membrane with a MWCO of from about 1,000 Da to about 30,000 Da, and more preferably up to about 10,000 Da, is used. Spiral-wound membranes of different MWCO are commercially and readily available. Suitable membranes are available from, for example, Koch Membrane Systems, Wilmington, Mass.; Osmonics, Minnetonka, Minn.; PTI Advanced Filtration, Oxnard, Calif.; and Synder Filtration, Vacaville, Calif.

During the ultrafiltration step, the temperature of the suspension can be lowered. One means of lowering the temperature is to include a heat exchanger in the ultrafiltration system and pass cold water through the heat exchanger. The heat exchanger may be installed prior to or after a pre-filter for the membrane system or within the membrane system itself.

The ultrafiltered soy protein product may be subjected to further heat treatment before being dried. As discussed above, in one embodiment, heat treating is done by jet cooking, under the conditions described above. In yet another embodiment, the ultrafiltered soy protein product may be heat treated in a steam-jacketed kettle. As discussed above, heat treatment acts to pasteurize or sterilize the product so that the product achieves an acceptable microbial profile and tests negative for microbes such as salmonella.

The heat treated soy protein product may then be dried. In one embodiment, drying may be done by spray drying using, for example, a vertical spray dryer with a high-pressure nozzle. Alternatively, the heat treated soy protein product can be freeze dried, or dried in another conventional manner.

The resulting soy protein product may be either a soy protein concentrate or a soy protein isolate. In one embodiment, the soy protein product is a soy protein concentrate having from at least about 65 wt. % (dry basis) to less than 90 wt. % (dry basis) soy protein, and more typically from about 65 wt. % (dry basis) to about 80 wt. % (dry basis) soy protein. In another embodiment, the soy protein product is a soy protein isolate having at least 90 wt. % (dry basis) soy protein, and more typically at least 92 wt. % (dry basis) soy protein.

The soy protein product preferably has a total fat content as measured by acid hydrolysis of at least about 6 wt % (dry weight basis). Preferably, the soy protein product has a total fat content as measured by acid hydrolysis of about 6 wt. % (dry weight basis) to about 20 wt % (dry weight basis), more preferably about 8 wt % (dry weight basis) to about 18 wt % (dry weight basis), and more preferably about 9 wt % (dry weight basis) to about 15 wt % (dry weight basis).

The fat content of the soy protein product may also be expressed in terms of the total amount of crude fat (sometimes referred to as petroleum ether extraction) present in the product. The total amount of crude fat in the soy protein product can be measured using a crude fat procedure according to the Official Methods of Analysis of the AOAC International, 16th Edition, Method 920.39C, Locator # 4.5.01 (Modified). Briefly, this method involves preparing the petroleum ether by washing commercial petroleum ether with two or three portions of water, followed by the addition of solid sodium hydroxide or potassium hydroxide. The petroleum ether is permitted to stand until most of the water is abstracted from the petroleum ether. The petroleum ether is decanted into dry bottle and small pieces of carefully cleaned metallic sodium are added and the petroleum ether is permitted to stand until hydrogen evolution ceases. The dehydrated petroleum ether is stored over metallic sodium in a loosely stopper bottle. Specifically, the following procedure may be used.

A 2.0 g sample of soy protein is extracted with five 20 ml portions of water. The soy protein is dried and put into a thimble with porosity permitting rapid passage of petroleum ether. The petroleum ether is added to the thimble contents at a rate of 5-6 drops per second for 4 hours up to 2-3 drops per second for 16 hour petroleum ether extract is dried to recover the crude fat which is reported as a percent of the total starting protein sample.

In one embodiment, the soy protein product comprises a crude fat content of less than about 3 wt. % (dry weight basis). Preferably, the soy protein product has a crude fat content of less than about 2 wt. % (dry weight basis), and more preferably less than about 1.5 wt % (dry weight basis). As discussed above, the relatively low crude fat percentage illustrates the ability of the fat and the soy proteins present in the sample to form an emulsion during processing.

Advantageously, the soy protein product has good solubility. For example, the solubility of the proteins may be expressed in terms of the Nitrogen Solubility Index (NSI). As used herein, NSI is defined as:
NSI=(% water soluble nitrogen of a protein containing sample/% total nitrogen in protein containing sample)×100

The nitrogen solubility index provides a measure of the percent of water soluble protein relative to total protein in a protein containing material. The nitrogen solubility index of a soy material is measured in accordance with standard analytical methods, specifically A.O.C.S. Method Ba 11-65, which is incorporated herein by reference in its entirety. According to the Method Ba 11-65, 5 grams of a soy material sample ground fine enough so that at least 95% of the sample will pass through a U.S. grade 100 mesh screen (average particle size of less than about 150 microns), is suspended in 200 milliliters of distilled water, with stirring at 120 rpm, at 30° C. (86° F.) for two hours, and then is diluted to 250 milliliters with additional distilled water. If the soy material is a full-fat material the sample need only be ground fine enough so that at least 80% of the material will pass through a U.S. grade 80 mesh screen (approximately 175 microns), and 90% will pass through a U.S. grade 60 mesh screen (approximately 205 microns). Dry ice should be added to the soy material sample during grinding to prevent denaturation of the sample. Forty milliliters of the sample extract is decanted and centrifuged for 10 minutes at 1500 rpm, and an aliquot of the supernatant is analyzed for Kjeldahl protein to determine the percent of water soluble nitrogen in the soy material sample according to A.O.C.S Official Methods Bc 4-91 (1997), Ba 4d-90, or Aa 5-91, each hereby incorporated by reference in their entirety. A separate portion of the soy material sample is analyzed for total protein using a Kjeldahl or Kjel-Foss analysis, such as the Nitrogen-Ammonia-Protein Modified Kjeldahl Method, described above, to determine the total nitrogen in the sample. The resulting values of Percent Water Soluble Nitrogen and Percent Total Nitrogen are utilized in the formula above to calculate the Nitrogen Solubility Index.

Typically, when testing the soy protein products of the present disclosure, the soy protein products have a Nitrogen Solubility Index of at least about 75%, more preferably at least about 80%, and still more preferably, at least about 85%.

Advantageously, because the soy protein products of the present disclosure are produced using a partially defatted starting material, the soy protein products of the present disclosure may comprise an increased amount of sterols (used herein interchangeably with the term “phytosterols”) as compared to other commercially available soy protein products that are produced using a fully defatted starting material. The amount and type of sterols present in the soy protein product may be determined in accordance with standard analytical methods, specifically the Official Methods of Analysis of the AOAC, Method 994.10, which is incorporated herein by reference in its entirety. Briefly, using Method 994.10, the fat portion of the soy protein product is saponified at a high temperature with an ethanolic KOH solution, and the unsaponifiable fraction containing the sterols is extracted with toluene. The sterols are then derivatized to trimethylsilyl (TMS) ethers and quantified by gas chromatography. Specifically, the following procedure may be used.

Saponification

A 2-3 g sample (test portion) (W₁) of the soy protein product is placed into an Erlenmeyer flask. A magnetic stir bar is added to the flask along with 40 mL of 95% ethanol and 8 mL of a 50% (w/w) KOH solution. The flask is placed on a magnetic stirrer-hot plate and attached to a condenser, and the solution containing the test portion is refluxed for 60 to 80 minutes, and preferably for 70 minutes, to saponify the test portion. During saponification, clumps in the test portion can be dispersed manually (e.g., with a glass rod) or by adding more of the KOH solution to the test portion while stirring.

After reflux is complete, the heat is turned off and 60 mL of 95% ethanol is added to the test portion through the top of the condenser while stirring. After about 15 minutes, the flask is removed from the condenser, closed with a stopper, and the saponified test portion is cooled to room temperature.

Extraction

Following saponification, 100 mL of toluene (VI) is added to the saponified test portion while stirring. The flask is then stoppered and stirred for at least 30 seconds. The resulting solution is poured into a 500 mL separatory funnel. 110 mL of 1M KOH solution is added, and the funnel is shaken vigorously for 10 seconds. The resulting mixture is allowed to separate into a toluene layer and an aqueous layer, and the lower aqueous layer is discarded. Forty mL of 0.5 M KOH solution is then added to the remaining toluene layer, the funnel is inverted, and the contents are gently swirled for about 10 seconds. The resulting mixture is again allowed to separate, and the lower aqueous layer is discarded. The toluene layer is then washed with 40 mL of water by gently rotating the separatory funnel. The layers are allowed to separate, and the aqueous layer is again discarded. The water wash is repeated at least 3 times, with more vigorous shaking each time.

After washing, the toluene layer is poured through a glass funnel containing a plug of glass wool and about 20 g of Na₂SO₄ into an Erlenmeyer flask containing about 2 g of Na₂SO₄. The flask is stoppered and the contents swirled. The resulting mixture is generally allowed to stand for about 15 minutes (and up to about 24 hours).

Twenty five mL of the resulting extract (V₂) is subsequently pipetted into a 125 g flat-bottom boiling flask and evaporated to dryness on a rotary evaporator at a temperature of about 37-43° C., and preferably 40° C. About 3 mL of acetone is added to the flask and the contents are again evaporated to dryness. The resulting residue is dissolved in 3.0 mL of dimethylformamide (DMF) (V₃) SO that the final sterol concentration in the DMF is within the range of working standard solutions (described below).

Derivatization

One mL aliquots of the test solution (described above) and working standard solutions at concentrations of 0.0025 mg/mL, 0.005 mg/mL, 0.01 mg/mL, 0.05 mg/mL, 0.1 mg/mL, and 0.2 mg/mL, are pipetted into separate 15 mL silanized centrifugation tubes, and 0.2 mL of hexamethyldisilane (HMDS) and 0.1 mL of trimethylchlorosilane (TMCS) are added to each tube. The working standard solution will vary depending on the sterol being detected, and may readily be determined by one skilled in the art. For example, when testing for campesterol, a campesterol standard solution available from ChromaDex (Santa Ana, Calif.) may be used; when testing for stigmasterol, a stigmasterol standard solution available from Sigma-Aldrich, Co. (St. Louis, Mo.) may be used; and when testing for β-sitosterol, a β-sitosterol standard solution available from Sigma-Aldrich, Co. (St. Louis, Mo.) may be used.

The tubes are stoppered and shaken vigorously for 30 seconds. The resulting solution is allowed to stand undisturbed for 15 minutes. 1.0 mL of Sa-cholestane internal standard solution (i.e., 0.1 mg/mL of 5α-cholestane in n-heptane) and 10 mL of water are added to each tube. The tubes are stoppered, vigorously shaken for 30 seconds, and centrifuged for about 2 minutes. A portion of the resulting heptane (upper) layer is then transferred to an injection vial.

Gas Chromatograph Analysis

The sterol content in the test portion may then be determined via analysis with a gas chromatograph. A volume of the test sample and standards (e.g., 1 μL) is injected into a gas chromatograph. The area of the 5α-cholestane and sterol peaks are determined using a height-width measurement or digital integrator. The sterol peak area is divided by the internal standard peak area to obtain a standard response ratio. Response ratios of the 4 high standards (e.g., the standards with a DMF concentration of 0.01, 0.05, 0.1, and 0.2 mg/mL) are plotted against the sterol concentrations. The grams of test portion/mL derivitized is calculated using the following formula:
g test portion/mL derivitized=(W₁/V₁)×(V₂/V₃)
wherein W₁=weight of test portion in grams; V₁=volume of toluene used in the extraction (i.e., 100 mL); V₂=aliquot of extract evaporated to dryness (i.e., 25 mL); and V₃=volume of DMF used to dissolve the residue (i.e., 3 mL).

The sterol content of the test portion may then be calculated using the following formula:
mg sterol/100 g test portion=(mg/mL sterol in test portion from standard curve×100)/(g test portion/mL derivitized).

Although the amount of sterols present in the soy protein products of the present disclosure will vary depending on the amount of sterols in the partially defatted soybean starting material, in general, the total amount of sterols present in the soy protein product is at least about 200 parts per million (ppm) (total dry matter), more typically at least about 300 ppm (total dry matter), more preferably at least about 500 ppm (total dry matter), more preferably at least about 600 ppm (total dry matter), and still more preferably at least about 800 ppm (total dry matter).

Several different types of sterols may be present in the soy protein product including, for example, compesterol, stigmasterol, and β-sitosterol, among others.

In another embodiment, the soy protein products of the present disclosure advantageously may comprise an increased amount of tocopherols, as compared to other commercially available soy protein products. The amount and type of tocopherols present in the soy protein product may be determined in accordance with standard analytical methods, including, for example, the American Oil Chemist Society (A.O.C.S.) Method Ce 8-89, among others. For example, in one method, the tocopherol content is determined by dissolving a sample of the soy protein product in isopropanol or extracting the fat from the soy protein product with methanol at room temperature. The dissolved sample or extract may then be analyzed by reverse phase liquid chromatography and the tocopherol content detected using fluorescence detection. The amount and type of tocopherol present in the sample can be quantified by running standards with known concentrations of tocopherol through the chromatograph.

Although the amount of tocopherols present in the soy protein products of the present disclosure will vary depending on the amount of tocopherols present in the partially defatted soybean starting material, in general, the total amount of tocopherols present in the soy protein product is at least about 5 ppm (total dry matter), more typically at least about 7 ppm (total dry matter), more preferably at least about 10 ppm (total dry matter), and still more preferably at least about 12 ppm (total dry matter).

Several different types of tocopherols may be present in the soy protein product including, for example, δ-tocopherol, γ-tocopherol, and α-tocopherol, among others.

In addition, because the partially defatted soybean starting material is produced without the use of organic solvents, the soy protein products of the present disclosure advantageously are free from organic solvents. Organic solvents may include, for example, hexane and heptane.

The soy protein product of the present disclosure has many uses. For example, it can be used as a milk substitute and in drink mixes and beverages, such as chocolate, vanilla and pineapple beverages; dairy products, such as fruit yogurt; nutrition and health products, such as protein bars; whole muscle meat injection; surimi products; emulsified meats; meat analogs; cereal products, such as breakfast cereals; bakery products, such as blueberry muffins and other liquid or dry beverage, food or nutritional products. The dried product may be coated with commercial lecithin or other food-grade surfactants, such as mono-diglycerides, to improve water dispersibility and reduce clumping of the product.

Having described the disclosure in detail, it will be apparent that modifications and variations are possible without departing from the scope of the disclosure defined in the appended claims.

Example 1 embodies the present invention. In Example 1, a soy protein concentrate is produced from partially defatted soy flour. The results of Example 1 are tabulated in Table 1, and are on a moisture free basis. Tabulated in Table 2 are the results of commercially available soy protein concentrates Alpha® 5800 and Promine® 3275 and commercially available soy protein isolates SUPRO® 500E, SUPRO® 670, and SUPRO® 760, all of which are available from The Solae Company (St. Louis, Mo.). The results tabulated in Table 2 are on an as-is basis, that is moisture containing, unless identified otherwise as a moisture free basis, (mfb).

The following non-limiting examples are provided to further illustrate the present disclosure.

### EXAMPLE 1

In this Example, a soy protein concentrate is produced from partially defatted soy flour, and the content of the soy protein concentrate determined.

Soy flour (US Soy, Mattoon, Ill.) that is partially defatted using mechanical expression, is obtained. The soy flour comprises 45.8% protein content on moisture-free basis and has a PDI (protein dispersibility index) of 68.4%, and a fat content by acid hydrolysis of 13.7%.

About 408 liters (900 pounds) of water are added to a mixing tank and heated to a temperature of about 32° C. (90° F.). Then, about 40.8 kilograms (90 pounds) of the partially defatted soy flour is added to the mixing tank to form a slurry. The pH of the slurry is adjusted to about 9.7, using a dilute sodium hydroxide (NaOH) solution (10:1 water:NaOH ratio). The resulting slurry is mixed for 10 minutes at a temperature of about 32° C. (90° F.) and then transferred to a centrifuge feed tank. The slurry is fed at a rate of about 7.6 liters (2 gallons) per minute to a Sharpless scroll-type centrifuge. The resulting supernatant is collected. The centrifuge cake is diluted using 245 liters (540 pounds) of water preheated to 32° C. (90° F.). The diluted cake is mixed for 10 minutes and is fed at a rate of about 7.6 liters (2 gallons) per minute to a Sharples scroll-type centrifuge. The supernatants (suspensions) from both centrifugations are mixed together and the pH is adjusted to 7.0 using a dilute hydrochloric acid solution (10:1 water:HCl ratio). The combined pH adjusted suspension is jet cooked at a temperature of about 127° C. (260° F.), passed through a shear pump (Dispax Reactor Model DR 3-6/6A equipped with fine, fine, and superfine generators in series, operating at 8000 rpm, IKA Works, Wilmington, N.C.), held for 30 seconds, and then flashed into a flash cooler with 15″ of vacuum. The jet-cooked and flash cooled suspension is further cooled to 27° C. (80° F.) and transferred to a membrane feed tank through a 100-mesh strainer. The suspension is fed to an ultrafiltration membrane system containing two spiral-wound membranes with a molecular weight cut off(MWCO) of 10,000 Da. The temperature of the suspension is maintained at about 27° C. (80° F.) during membrane processing. The ultrafiltration system is operated at an inlet pressure of 50 pounds per square inch and outlet pressure of 35 pounds per square inch. About 87% of the original feed volume added to the membrane feed tank is removed as permeate. The retentate from the membrane system is pasteurized at a temperature of about 82° C. (180° F.) for 30 seconds and spray dried using a high-pressure pump feeding a spray nozzle in a vertical spray dryer.

The dried product of Example 1 is analyzed to determine the content thereof. The fat content by acid hydrolysis, total sterol content, total tocopherol content, crude fat content, and the Nitrogen Solubility Index are measured by the processes described above. The results of the analysis are shown in Table 1. All results are on moisture-free basis, unless otherwise noted.

TABLE 1
Composition of Example 1

| | Amount Determined in |
|---|---|
| Composition or Element Determined | Soy Protein Product |
| Protein (wt %,) | 68.25 |
| Fat Content by Acid Hydrolysis (wt %) | 14.59 |
| Ash (wt %) | 4.48 |
| Tocopherols, Total (ppm) | 12.07 |
| δ-Tocopherol (ppm) | 5.49 |
| γ-Tocopherol (ppm) | 6.58 |
| α-Tocopherol (ppm) | <1.0 |
| Sterols, Total (ppm) | 842.7 |
| Campesterol (ppm) | 153.6 |
| Stigmasterol (ppm) | 199.7 |
| β-Sitosterol (ppm) | 489.4 |
| Nitrogen Solubility Index (NSI) (%) | 87.2 |
| Crude fat (wt. %) | 1.8 |

Commercially available soy protein concentrates and isolates are analyzed to determine their composition. The results of the analysis are shown in Table 2. All results are on as-is basis, unless otherwise stated (mfb=moisture free basis).

TABLE 2
Composition of Commercially Available Concentrates and Isolates

| | Amount Determined in Soy Protein Product | | | | |
|---|---|---|---|---|---|
| Composition or Element | Alpha | Supro | Supro | Supro | Promine |
| Determined | 5800 | 500E | 670 | 760 | 3275 |
| Protein (mfb)(weight | 79.3 | 89.1 | 89.9 | 92.0 | 66.1 |
| percent) | | | | | |
| Moisture (weight percent) | 5.81 | 5.95 | 6.10 | 5.37 | 6.77 |
| Fat by Acid Hydrolysis | 2.62 | 5.25 | 4.87 | 5.53 | 1.39 |
| (weight percent) | | | | | |
| Tocopherols, Total (ppm) | <1.0 | 1.7 | 3.4 | 1.2 | <1.0 |
| δ-Tocopherol (ppm) | <1.0 | 1.7 | 2.4 | 1.2 | <1.0 |
| γ-Tocopherol (ppm) | <1.0 | <1.0 | <1.0 | <1.0 | <1.0 |
| α-Tocopherol (ppm) | <1.0 | <1.0 | 1.0 | <1.0 | <1.0 |
| Sterols, Total (ppm) | 29 | 142 | 80 | 177 | 41 |
| Campesterol (ppm) | <10 | 27 | 16 | 30 | <10 |
| Stigmasterol (ppm) | <10 | 28 | 17 | 36 | <10 |
| β-Sitosterol (ppm) | 29 | 87 | 47 | 111 | 41 |
| Nitrogen Solubility | 68.4 | 45.2 | 60.0 | 34.4 | 63.9 |
| Index (NSI) (%) | | | | | |

It is noted that the product of Example 1 has significantly increased contents of fat by acid hydrolysis, total tocopherols, total sterols, and NSI in comparison to the commercially available concentrates and isolates.

While the invention has been explained in relation to its preferred embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A process for producing a soy protein product, the process comprising:
contacting a partially defatted soybean starting material having a fat content by acid hydrolysis of from about 6 wt. % (dry weight basis) to about 20 wt. % (dry weight basis) with a hydrating solution to form a slurry;
removing fiber from the slurry to produce a suspension; and
ultrafiltering the suspension using a membrane having a molecular weight cutoff of between about 1,000 Daltons and about 30,000 Daltons to form the soy protein product;
wherein the soy protein product has a protein content of at least about 65 wt. % (total dry matter) and a total sterol content of at least about 200 ppm (total dry matter).

2. The process of claim 1 further comprising heating the suspension to a temperature of from about 70° C. to about 130° C. for from about 9 seconds to about 30 seconds prior to ultrafiltering the suspension.

3. The process of claim 1 further comprising heating the soy protein product to a temperature of from about 70° C. to about 130° C. for from about 9 seconds to about 30 seconds.

4. The process of claim 1 further comprising spray drying the soy protein product.

5. The process of claim 1 wherein the partially defatted soybean starting material has a protein dispersibility index of at least about 60%

6. The process of claim 1 wherein the partially defatted soybean starting material is prepared without the use of an organic solvent.

7. The process of claim 1 wherein the soy protein product has a total tocopherol content of at least about 5 ppm (total dry matter).

8. The process of claim 1 wherein the soy protein product has a Nitrogen Solubility Index (NSI) of at least about 75%.

9. A process for producing a soy protein product, the process comprising:
contacting a partially defatted soybean starting material having a fat content by acid hydrolysis of from about 6 wt. % (dry weight basis) to about 20 wt. % (dry weight basis) with a hydrating solution to form a slurry;
removing fiber from the slurry to produce a suspension; and
ultrafiltering the suspension using a membrane having a molecular weight cutoff of between about 1,000 Daltons and about 30,000 Daltons to form the soy protein product;
wherein the soy protein product has a protein content of at least about 65 wt. % (total dry matter) and a total tocopherol content of at least about 5 ppm (total dry matter).

10. The process of claim 9 further comprising heating the suspension to a temperature of from about 70° C. to about 130° C. for from about 9 seconds to about 30 seconds prior to ultrafiltering the suspension.

11. The process of claim 9 further comprising heating the soy protein product to a temperature of from about 70° C. to about 130° C. for from about 9 seconds to about 30 seconds.

12. The process of claim 9 wherein the soy protein product has a total tocopherol content of at least about 10 ppm (total dry matter).

13. A soy protein product comprising a protein content of at least about 65 wt. % (total dry matter), a fat content by acid hydrolysis of at least about 6 wt. % (dry weight basis), and a total sterol content of at least about 200 ppm (total dry matter), wherein the sterol is selected from the group consisting of campesterol, stigmasterol, β-sitosterol, and combinations thereof.

14. The soy protein product of claim 13 wherein the soy protein product has a Nitrogen Solubility Index (NSI) of at least about 75%.

15. The soy protein product of claim 13 wherein the soy protein product has a total tocopherol content of at least about 5 ppm (total dry matter), wherein the tocopherol is selected from the group consisting of δ-tocopherol, γ-tocopherol, α-tocopherol, and combinations thereof.

16. The soy protein product of claim 13 wherein the soy protein product has a crude fat content of less than about 3 wt. % (dry weight basis).

17. A soy protein product comprising a protein content of at least about 65 wt. % (total dry matter), a fat content by acid hydrolysis of at least about 6 wt. % (dry weight basis), and a total tocopherol content of at least about 5 ppm (total dry matter), wherein the tocopherol is selected from the group consisting of δ-tocopherol, γ-tocopherol, α-tocopherol, and combinations thereof.

18. The soy protein product of claim 17 wherein the soy protein product has a Nitrogen Solubility Index (NSI) of at least about 75%.

19. The soy protein product of claim 17 wherein the soy protein product comprises at least one sterol selected from the group consisting of campesterol, stigmasterol, β-sitosterol, and combinations thereof.

20. The soy protein product of claim 17 wherein the soy protein product has a crude fat content of less than about 3 wt. % (dry weight basis).
